(19) United States
(12) Patent Application Publication
(10) Pub. No.: US 2015/0170098 A1
(43) Pub. Date: Jun. 18, 2015

(54) PERSONALIZING DELIVERY CHOICES

(71) Applicant: eBay Inc., San Jose, CA (US)

(72) Inventors: Dane Glasgow, Los Altos, CA (US); Shannon B. Vosseller, San Francisco, CA (US); Michael Lenahan, Moraga, CA (US)

(73) Assignee: EBAY INC., SAN JOSE, CA (US)

(21) Appl. No.: 14/108,568

(22) Filed: Dec. 17, 2013

(51) Int. Cl. G06Q 10/08

(52) U.S. Cl. CPC G06Q 10/0834

(57) ABSTRACT

Systems and methods to personalize delivery choices are described. A buyer may make a delivery request; the delivery request may include transaction information. Available delivery choices may be identified based on the transaction information. Delivery analytics data associated with the transaction information may be retrieved from at least one application server. Personalized delivery choices from the identified available delivery choices may be determined based on an analysis of the delivery analytics data. The buyer may be recommended the personalized delivery choices.

### TECHNICAL FIELD

Embodiments of the present invention relate generally to systems and methods for personalizing delivery choices based on information from various sources.

### BACKGROUND

Modern delivery services offer a plethora of delivery choices. For example, same day delivery, locker-based pickup, air, ground, charter, hand-carry, dedicated courier, alternative delivery services, and many others. The distinction between these choices can be difficult to discern for a typical consumer. As the number of choices increases, the difficulty of making a choice often increases. Effective commercial enterprises try to avoid confusing or overloading consumers. Accordingly, it would be advantageous to develop a system and methods for providing personalized delivery choices from amongst a wide range of delivery choices.

### BRIEF DESCRIPTION OF THE DRAWINGS

Various ones of the appended drawings merely illustrate example embodiments of the present invention and cannot be considered as limiting its scope.

FIG. 1 is a block diagram of a networked system depicting an example embodiment.

FIG. 2 is a block diagram of application servers that may form a part of the network system of FIG. 1, according to example embodiments.

FIG. 3 is a block diagram illustrating social network information, according to an example embodiment.

FIG. 4 is a block diagram illustrating a mobile device, according to an example embodiment.

FIG. 5 is a block diagram depicting various components, according to example embodiments.

FIG. 6 is a block diagram depicting an example embodiment of coupling between various modules of FIG. 5.

FIG. 7 is a flow diagram illustrating an example embodiment for personalizing delivery choices.

FIGS. 8, 9, 10, and 11 are flow diagrams depicting embodiments of personalizing delivery choices.

FIG. 12 depicts an example user interface displaying available delivery choices.

FIG. 13 depicts an example user interface displaying personalized delivery choices.

FIG. 14 is an example embodiment of a computer system in conjunction with the present invention.

### DETAILED DESCRIPTION

Example methods and systems for personalizing delivery choices are described. In the following description, for purposes of explanation, numerous specific details are set forth in order to provide a thorough understanding of example embodiments. It will be evident, however, to one skilled in the art that the present invention may be practiced without these specific details.

Embodiments described herein may include personalizing delivery choices based on information from various sources. Given a wide range of delivery choices, delivery choices that are personalized to a buyer are determined based on information from various sources. The sources may include third party servers, for example. The information used to determine the personalized delivery choices may include, for example, buyer information, seller information, item information, and other information. For example, if the buyer has favored faster delivery choices in the past, the personalized delivery choices may include speedier delivery choices. Example information that may be used in determining the personalized delivery choices may include age, region, shipping origin, shipping destination, socioeconomic status, prior delivery choice selections, information from the buyer's social network presence, seller location, buyer location, delivery routes, item origination location, multiple item origination locations (e.g., seller may have the item in multiple locations), shipping cost, whether the item to be delivered is perishable, whether the delivery is time sensitive, weather conditions, current closures, current shipping volumes, shipping delays, power outages, geopolitical events, fuel shortages, strikes, other buyer delivery preferences from the same region as the buyer, and other information. This information may be referred to as delivery analytics data and includes a wide range of information from various sources. The delivery analytics data may be analyzed and used in a number of different schemes to determine personalized delivery choices.

In some embodiments, an item may have multiple origination locations. For example, a seller may have a particular item in more than one location, or multiple sellers may have the particular item. In this example, the personalized delivery choices may be determined based multiple item origination locations that may include multiple sellers.

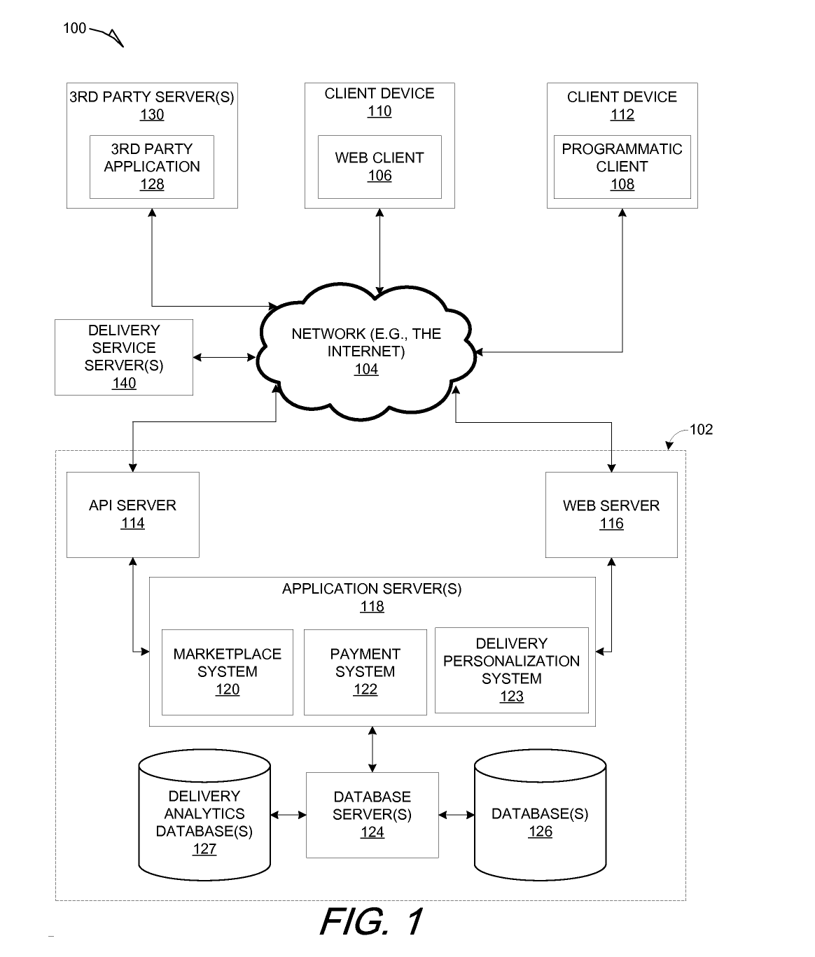

With reference to FIG. 1, an example embodiment of a high-level client-server-based network architecture 100 to enable personalizing delivery choices is shown. A networked system 102, in the example forms of a network-based marketplace or publication system, provides server-side functionality, via a network 104 (e.g., the Internet or Wide Area Network (WAN)) to one or more client devices 110 and 112. FIG. 1 illustrates, for example, a web client 106 (e.g., a browser, such as the Internet Explorer browser developed by Microsoft Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screen, accelerometer, gyroscope, camera, microphone, and GPS device. The client devices 110 and 112 may be a device of a user, which is used to perform a transaction involving digital goods within the networked system 102. In one embodiment, the networked system 102 is a network-based marketplace that manages digital goods, publishes publications comprising item listings of products available on the network-based marketplace, and manages payments for these marketplace transactions.

An Application Program Interface (API) server 114 and a web server 116 are coupled to, and provide programmatic and web interfaces respectively to, one or more application servers 118. The application servers 118 may host one or more marketplace systems 120, payment systems 122, and delivery personalization systems 123 each of which may comprise one or more modules or applications and each of which may be embodied as hardware, software, firmware, or any combination thereof. The application servers 118 are, in turn, shown to be coupled to one or more databases servers 124 that facilitate access to one or more to one or more information storage repositories or database(s) 126. In one embodiment, the databases 126 are storage devices that store information to be posted (e.g., publications or listings) to the publication system 120. The databases 126 may also store digital goods information in accordance with example embodiments.

In an example embodiment, the application servers 118 are coupled to one or more delivery analytics database(s) 127. The delivery analytics databases 127 may store delivery analytic information used to personalize delivery choices. For example, past delivery choice selections and information associated with the past delivery choice selections may be stored and retrieved from delivery analytics databases 127.

The marketplace system 120 may provide a number of marketplace functions and services to users that access the networked system 102. The payment system 122 may likewise provide a number of payment services and functions to users. The payment system 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace system 120. The delivery personalization system 123 may provide functionality for personalizing delivery choices using information from various sources. While the marketplace, payment, and delivery personalization systems 120, 122, and 123 are shown in FIG. 1 to both form part of the networked system 102, it will be appreciated that, in alternative embodiments, the payment system 122 may form part of a payment service that is separate and distinct from the networked system 102. Similarly, it is to be appreciated that delivery personalization system 123 may also be separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace, payment, and delivery personalization systems 120, 122, and 123 could also be implemented as standalone software programs, which do not necessarily have networking capabilities.

The web client 106 accesses the various marketplace, payment, and delivery personalization systems 120, 122, and 123 via the web interface supported by the web server 116. Similarly, the programmatic client 108 accesses the various services and functions provided by the marketplace, payment, and delivery personalization systems 120, 122, and 123 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

Delivery service server(s) 140 may be coupled to network 104 in an example embodiment. The delivery service servers 140 may provide delivery service information and may receive requests to initiate delivery of one or more items. For example, the delivery personalization system 123 may communicate with the delivery service servers 140 via network 104 to retrieve delivery information or request delivery of items.

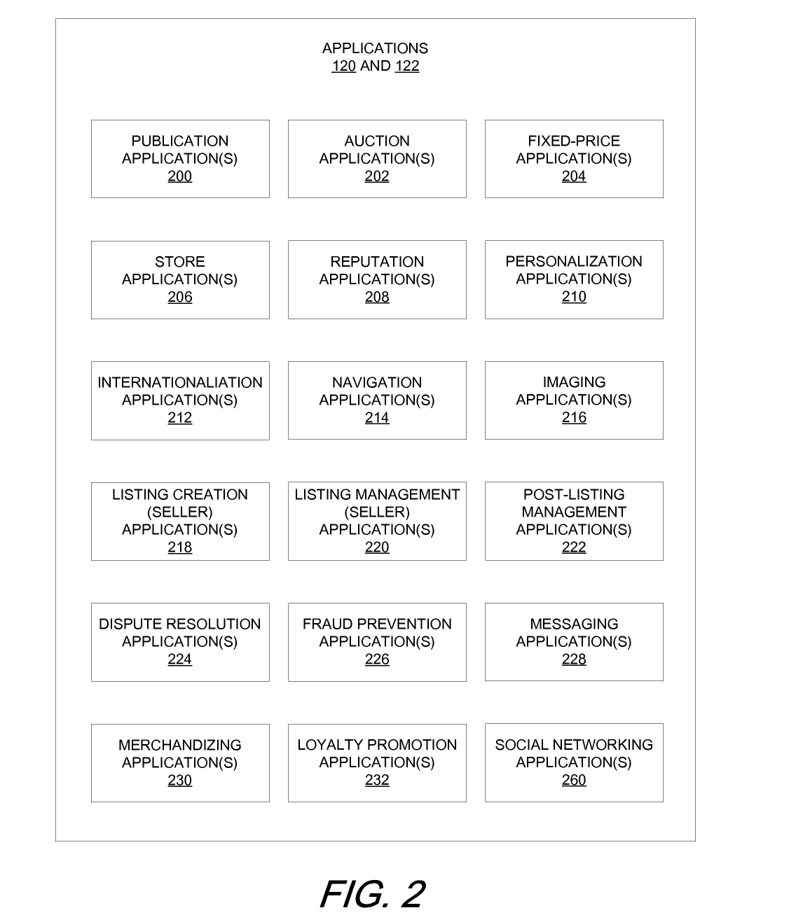

FIG. 2 is a block diagram illustrating multiple applications 120 and 122 that, in one example embodiment, are provided as part of the networked system 102. The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace system 120 is shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browser application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace system 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

Social networking applications 260 may support various social networking functions that are made available in various embodiments. The social networking functions may include the retrieval or submission of data to and from social networking servers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

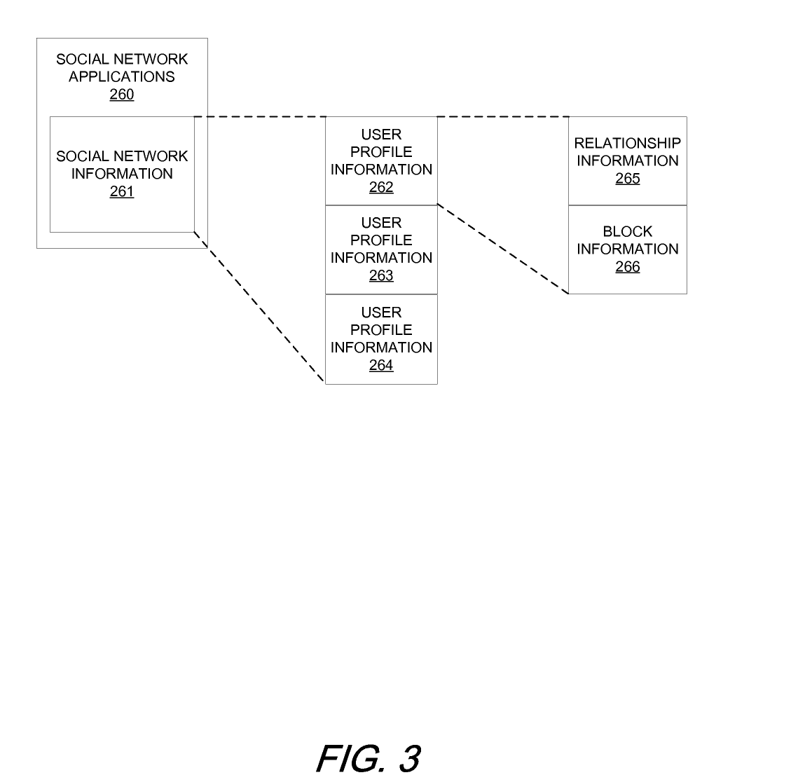

FIG. 3 is a block diagram illustrating social network information 261 that may be used by social network applications 260 of FIG. 2, according to an embodiment, at the network-based social publisher 102 of FIG. 1. The social network application(s) 260 is shown to include social platform user profile information 261 that stores user profile information 262 for users of the network-based publisher 102. The user profile information 262 may include information related to the user and specifically may include relationship information 265 and block information 266. The relationship information 265 may store a predetermined relationship between the user associated with the user profile information 262 and other users on the network-based publisher 102. For example, a first user may be designated a “friend,” or “favorite friend,” etc. with a second user, the first user associated with the user profile information 262 and the respective designations associated with increasing levels of disclosure between the first user and second user. The block information 266 may store a configured preference of the user to block the addition of an item by other users to a watch list associated with the user.

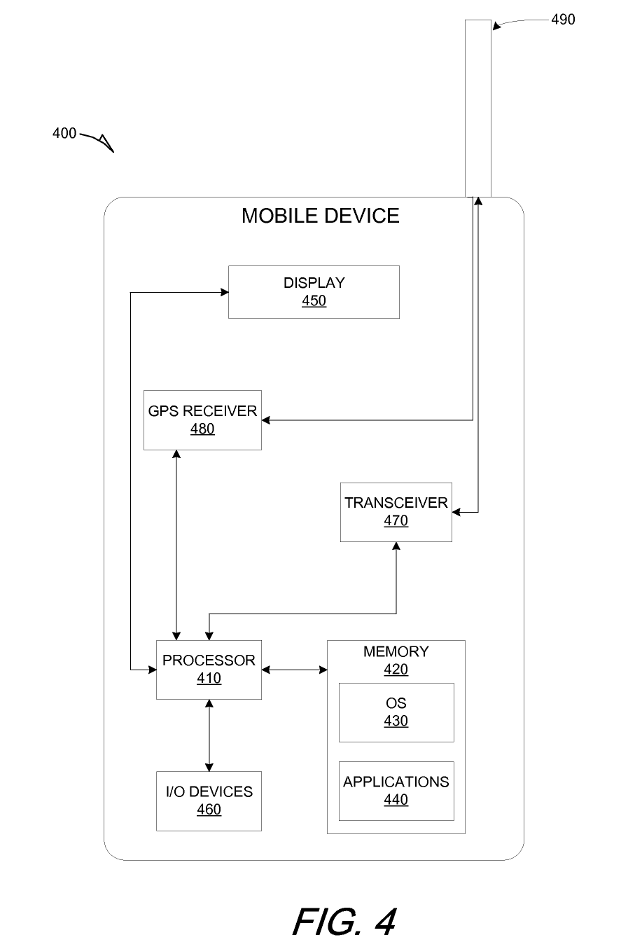

FIG. 4 is a block diagram illustrating a mobile device 400, according to an example embodiment. The mobile device 400 may include a processor 410. The processor 410 may be any of a variety of different types of commercially available processors suitable for mobile devices (e.g., an XScale architecture microprocessor, a Microprocessor without Interlocked Pipeline Stages (MIPS) architecture processor, or another type of processor). A memory 420, such as a Random Access Memory (RAM), a Flash memory, or other type of memory, is typically accessible to the processor. The memory 420 may be adapted to store an operating system (OS) 430, as well as application programs 440, such as a mobile location enabled application that may provide LBSs to a user. The processor 410 may be coupled, either directly or via appropriate intermediary hardware, to a display 450 and to one or more input/output (I/O) devices 460, such as a keypad, a touch panel sensor, a microphone, and the like. Similarly, in some embodiments, the processor 410 may be coupled to a transceiver 470 that interfaces with an antenna 490. The transceiver 470 may be configured to both transmit and receive cellular network signals, wireless data signals, or other types of signals via the antenna 490, depending on the nature of the mobile device 400. In this manner, a connection with a network such as network 104 of FIG. 1 may be established. Further, in some configurations, a GPS receiver 480 may also make use of the antenna 490 to receive GPS signals. Additional details regarding providing and receiving location-based goods and services using a GPS system can be found in U.S. patent application Ser. No. 13/340,626 entitled “Methods and Systems for Using a Co-Located Group as an Authorization Mechanisms,” assigned to the assignee of the instant application, which application is hereby incorporated by reference in its entirety.

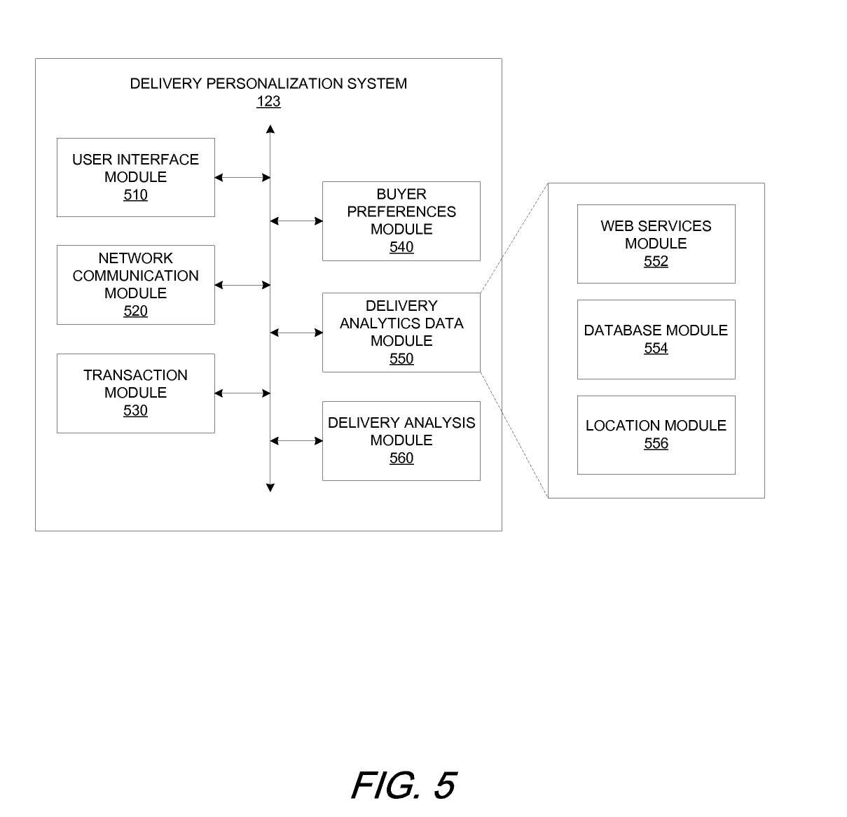

FIG. 5 is a block diagram of the delivery personalization system 123, which may determine personalized delivery choices for a buyer using information from various sources. In one embodiment, the delivery personalization system 123 includes a user interface module 510, a network communication module 520, a transaction module 530, a buyer preferences module 540, a delivery analytics data module 550, and a delivery analysis module 560. In further embodiments, the delivery analytics data module 550 may include a web services module 552, a database module 554, and a location module 556. Other modules not pertinent to example embodiments may also be included, but are not shown.

The user interface module 510 may provide various user interface functionality that may present and receive information from the buyer. For example, the user interface module 510 may present a delivery choice interface to the buyer that displays various delivery choices and may receive a delivery choice selection from the buyer. The user interface module 510 may also provide a buyer preferences user interface that may receive preferences from the buyer. Information may be presented by a number of means including displaying information (e.g., such as on display 450), other visual means, or other device output (e.g., audio, tactile, and so forth). Similarly, information may be received by a number of means including alphanumeric input on a keyboard or other device input (e.g., one or more touch screen, camera, tactile sensors, light sensors, infrared sensors, biometric sensors, microphone, gyroscope, accelerometer, other sensors, and so forth). The user interface module 510 may provide many other user interfaces to facilitate functionality described herein.

The network communication module 520 may perform various network communication functions such as communicating with the client devices 110 and 112 and servers such as the delivery service servers 140, the database servers 124 and the third party servers 130. Network communication may operate over WiFi, Bluetooth, or other means of wired or wireless data transmission.

The transaction module 530 may receive transaction information and delivery requests from application servers 118 or client devices 110 and 112, in an example embodiment. In embodiments, the transaction module 530 may receive a delivery choice selection from the buyer. Furthermore, the transaction module 530 may communicate with the delivery service servers 140 to determine available delivery choices based on the transaction information, retrieve delivery choice information, and initiate delivery. The transaction information may comprise seller information, buyer information, item information, and other transaction information. For example, the transaction information may include a time of transaction, a shipping origin, a shipping destination, a buyer identifier, a seller identifier, an item identifier, an item name, a seller name, a buyer name an item model, an item price, an item weight, item dimensions, and so forth. The delivery choice information may include carrier, cost, pickup times, estimated arrival times, packaging information, whether delivery is temperature controlled regions where delivery is available, delivery drop off type, and so forth.

The buyer preferences module 540 may provide functionality to receive and store buyer delivery preferences. The buyer preferences module 540 may receive the buyer delivery preferences from the buyer to be stored in delivery analytics databases 127, in an example embodiment. For example, the buyer may specify that a low cost delivery choice is preferable for certain items, item types, or all items. In further embodiments, the buyer may specify the buyer delivery preferences for certain items, item types, or all items including the location for delivery, the carrier, faster delivery choices, lower cost delivery choices, safer handling delivery choices, temperature controlled delivery choices, a schedule of available delivery times, a party or parties who may receive the delivery, a pickup location for the delivery, and so forth. In some embodiments, the buyer delivery preferences from other buyers may also be retrieved. For example, all the buyer delivery preferences for other buyers in a particular region may be used to determine a preferable delivery method for the buyer given the buyer's location.

The delivery analytics data module 550 may retrieve delivery analytics data associated with the transaction information. The delivery analytics data may be retrieved from a plurality sources. For example, the delivery analytics data may be retrieved from the client device 110 and 112, the database servers 124, the application servers 118, the third party servers 130 (e.g., social network servers, government servers, commercial servers, or other third party servers), or other sources. The delivery analytics data module 550 may also store information in delivery analytics databases 127. For example, information associate with the transaction, such as the delivery choice selection for a particular item, may be stored in one or more databases such as the delivery analytics databases 127.

The delivery analytics data module 550 may retrieve a buyer profile that is associated with the transaction information, in an example embodiment. The buyer profile may include, for example, age, gender, location, region, employment status, marital status, real-time location, income level, socioeconomic status, prior delivery choice selections, information from the buyer's social network profiles, and so forth. In embodiments, the buyer location may include a plurality of locations. In further embodiments, the buyer location may be a dynamic location (e.g., a location currently being updated by GPS, IP address geolocation, and other geographic services).

In a further embodiment, the delivery analytics data module 550 may retrieve a seller profile that is associated with the transaction information for the one or more sellers included in the transaction information. The seller profile may include, for example, location, region, packaging type, on-time delivery statistics, other seller statistics, and so forth. In some embodiments, the seller profile information may be associated with one or more sellers (e.g., multiple sellers that are currently selling a particular item). For example, the delivery analytics data may include item locations, delivery route, delivery dates, and shipping cost for items associated with multiple sellers. In this example, the personalized delivery choices may be determined based on the information from multiple sellers (e.g., delivery choices with the fastest delivery across multiple sellers or lowest cost delivery across multiple sellers).

The delivery analytics data module 550 may retrieve an item profile that is associated with the transaction information for items included in the transaction data, in some embodiments. The item profile may include for example, price, weight, dimensions, whether the item is perishable, whether the item requires time sensitive delivery, whether the item needs to be in a temperature controlled environment, whether the item is sensitive to direct sunlight, packaging material requirements, item origination location, multiple item origination locations (e.g., seller may have the item in multiple locations) and so forth.

In yet another embodiment, the delivery analytics data module 550 may retrieve a transaction profile that is associated with the transaction information. The transaction profile may include, for example, weather conditions at various locations, current road closures, power outages, shipping delays, current shipping volumes, fuel shortages, strikes, shipping costs, delivery routes and so forth. The information in the transaction profile may be based on the transaction information. For example, the location of the buyer may be used to determine weather conditions at the buyer's location at potential delivery times. In another example, the transaction time may be used as a basis for determining whether current shipping volume is high (e.g., during holiday seasons).

The web services module 552 may perform various web services functions such as retrieving information from third party servers 130 and application servers 118. Information retrieved by the web services module 552 may include information in the buyer profile, the seller profile, the item profile, the transaction profile, or other information.

The database module 554 may communicate with the delivery analytics databases 127 and other databases to retrieve and store information. For example, the delivery choice selection made by the buyer may be stored in the delivery analytics databases 127. Further, other information associated with the delivery choice selection may be stored in the delivery analytics databases 127, such as, item, delivery service, time of day, time of week, time of year, and so forth. In further embodiments, other information associated with the buyer, the seller, the item, or other information may be stored or retrieved in the delivery analytics databases 127.

The location module 556 may retrieve various location information associated with the transaction information. Location information of the buyer may be retrieved, for example, using IP address geolocation or from other geographic services. In further embodiments, real-time location information may be retrieved from a buyer device using GPS (e.g., from GPS receiver 480) or another location service. Item location (e.g., current location of the item in transit or shipping origin) information may be retrieved from third party servers 130, delivery service servers 140, or from another source. Similarly, seller location may be retrieved from third party servers 130 or from another source.

The delivery analysis module 560 may receive information from various sources and analyze the information to determine personalized delivery choices. The analysis to determine personalized delivery choices may be performed in a variety of ways and using many different pieces of information. Different weights may be given to information in performing the analysis. Various schemes may be employed during the analysis to determine personalized delivery choices.

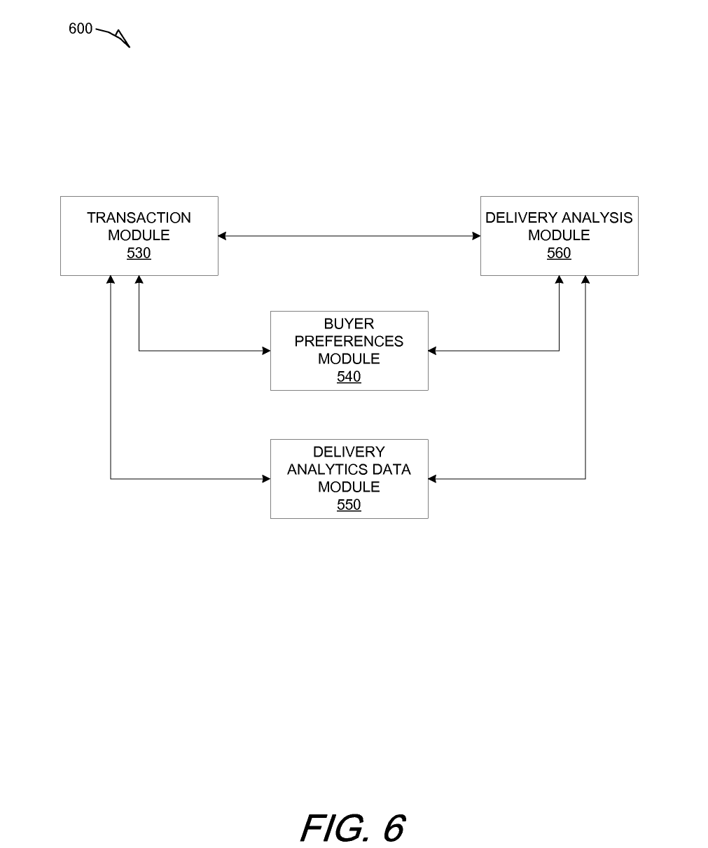

FIG. 6 depicts an example embodiment of coupling between various modules of the delivery personalization system 123. The delivery analysis module 560 may be coupled to the transaction module 530, the buyer preferences module 540, and the delivery analytics data module 550. In an example embodiment, the delivery analysis module 560 may receive transaction information and available delivery choices from transaction module 530, the buyer delivery preferences from the buyer preferences module 540, and the delivery analytics data from the delivery analytics data module 550.

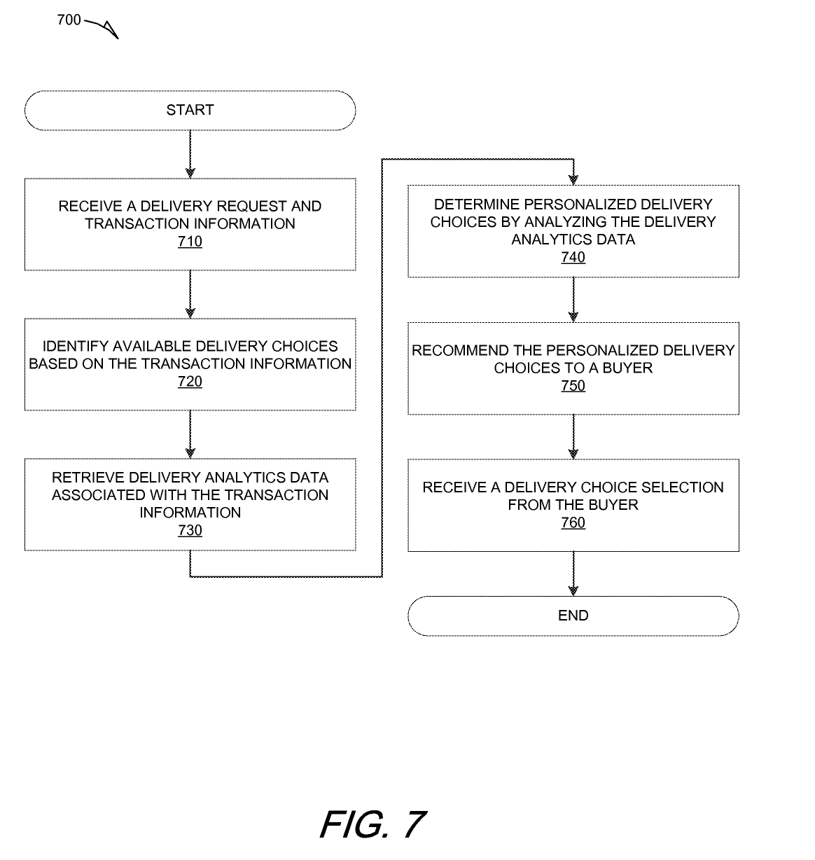

FIG. 7 is a flow diagram illustrating an example method 700 of personalizing delivery choices. At operation 710, the delivery personalization system 123 may receive the delivery request and the transaction information. In some embodiments, the delivery request may be received from the buyer, the buyer initiating the request from client device 110 and 112 or from application servers 118.

At operation 720, the delivery personalization system 123 may identify available delivery choices based the transaction information received at operation 710. For example, the transaction information may contain the delivery origin and the delivery destination and based on the delivery origin and the delivery destination the available delivery choices may be determined (e.g., a particular origin or destination may not have certain delivery services). In another example, the transaction information may contain item information, which may be used to determine available delivery choices (e.g., same-day delivery may not be available for very large items).

Once the available delivery choices are identified at operation 720, the delivery personalization system 123 may retrieve the delivery analytics data associated with the transaction information from at least one application server at operation 730. As detailed above, the delivery analytics data may encompass a wide range of information from a wide range of sources. In one embodiment, prior delivery choice selections may be retrieved for the buyer at operation 730.

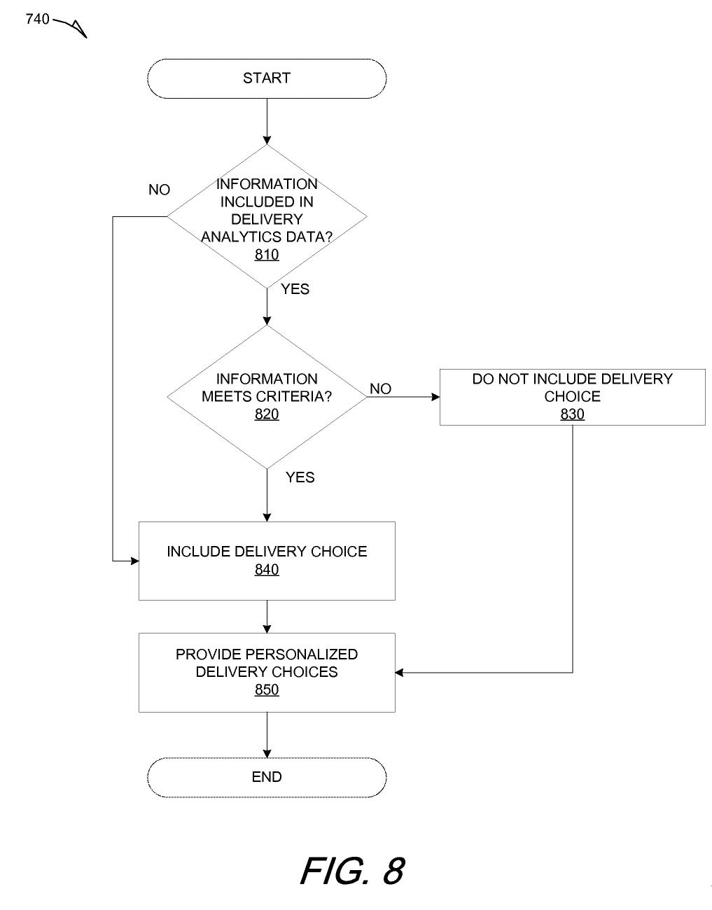

At operation 740, the delivery personalization system 123 may determine personalized delivery choices by analyzing the delivery analytics data retrieved at operation 730 as further described in FIGS. 8-11. In an example embodiment, prior delivery choices for the buyer may be used to determine a preferable delivery choice among the available delivery choices for the buyer.

After the personalized delivery choices are determined at operation 740, the delivery personalization system 123 may recommend the personalized delivery choices to the buyer at operation 750. The buyer may be recommended fewer choices than all of the available delivery choices. In an embodiment, the personalized delivery choices are ranked by most preferable to least preferable and the buyer may be recommended the delivery choices in a way that emphasizes the more preferable delivery choices. In some embodiments, the remaining available delivery choices may be presented to the buyer in addition to the recommended delivery choices.

At operation 760, the delivery personalization system 123 may receive a delivery choice selection from the buyer. In further embodiments, the delivery choice selection may be store in delivery analytics database 127. The delivery choice may be associated with the buyer, the transaction information, and other information.

FIG. 8 is an example embodiment of operation 740 that may analyze the delivery analytics data by evaluating the data against criteria. At operation 810, the delivery personalization system 123 may determine if the information is included in the delivery analytics data. If the information is not in the delivery analytics data, then the delivery choice may simply be included as though no criteria were evaluated. In other embodiments, the delivery choice may not be included. At operation 820, the delivery personalization system 123 may determine if the information meets criteria. Many criterions may be evaluated at operation 820. In an example embodiment, if the information meets the criteria, then the delivery choice is included at operation 840. Conversely, if the criteria are not met, then the delivery choice is not included at operation 830. At operation 850, the delivery personalization system 123 may provide the personalized delivery choices.

In an example embodiment, the information at operation 820 may be whether the item is temperature sensitive (e.g., some types of perishable items such as fine chocolate) and whether the delivery choice is temperature controlled. In this example, one criterion may be to require a temperature controlled delivery choice for a temperature sensitive item. Information regarding whether the item is temperature sensitive may be contained in the item profile information discussed herein. Information regarding whether the delivery choice may be temperature controlled may be contained in the delivery choice information described herein. In another example embodiment, the information at 820 may be whether the item to be delivered is time sensitive (e.g., concert tickets that have no value after the concert date). In this example, the one criterion at operation 820 may require that the delivery choice can complete delivery within a requisite time. Many other criteria and information may be evaluated at operation 820 to personalize the delivery choices.

In a further example embodiment, the delivery analytics data may include one or more item locations of the item for one or more sellers (e.g., a seller may have a particular item in more than one location). The delivery analytics data may also include delivery route information for each of the item locations. In an embodiment, the personalized delivery choices may be determined based on the item locations and delivery route information. For example, the delivery choices for items that are geographically closer to the buyer location may be preferable or delivery choices associated with items with the shortest delivery route.

In some embodiments, operation 740 may employ a scheme that incorporates many pieces of information. For example, it may be determined that delivery cost is not important to the buyer and delivery speed and delivery reliability are very important to the buyer. A scheme may be employed that assigns a numerical value to each delivery characteristic of the delivery choice such as speed, reliability, cost, and so forth. Furthermore, a numerical value may be assigned to the importance of the delivery characteristic to the buyer. In this example, delivery speed and delivery reliability may have a higher numerical value than delivery cost. Operation 820 may then determine if a delivery choice meets the criteria by analyzing the numerical value assigned the delivery choice characteristic and the numerical value assigned to the importance of the delivery characteristic to the buyer. Delivery choices with delivery characteristics that correspond well to important delivery characteristics of the buyer may meet the criteria at operation 820. Many other schemes may be employed.

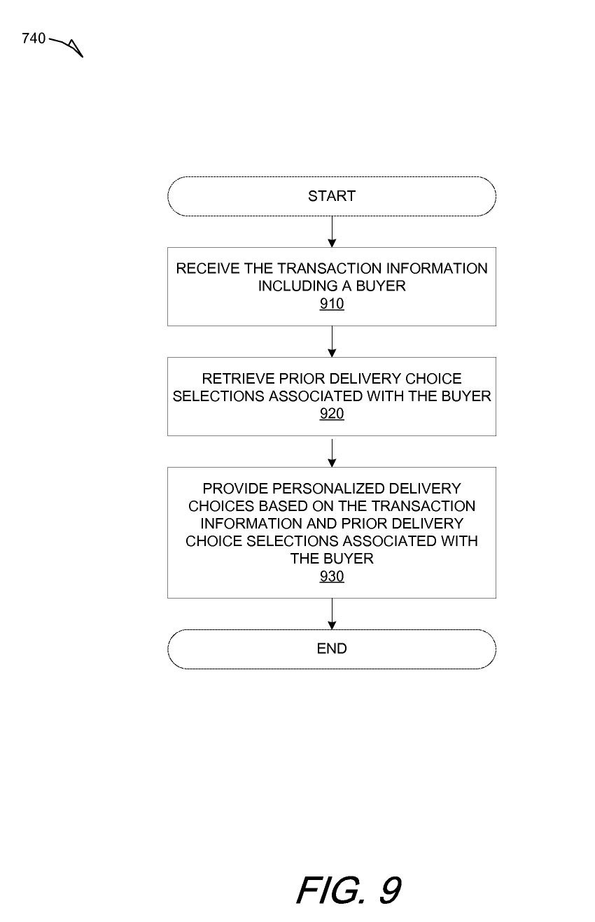

FIG. 9 is an example embodiment of operation 740 that may perform analysis of the delivery analytics data based on prior delivery choice selections of the buyer. At operation 910, the delivery personalization system 123 may receive the transaction information including a buyer (e.g., a buyer name or buyer identifier). As described herein, the transaction information may include item information and buyer information. This information may be utilized in subsequent operations.

At operation 920, the delivery personalization system 123 may retrieve prior delivery choice selections associated with the buyer. For example, the buyer information may be used to retrieve delivery choice selections that were previously stored in delivery analytics databases 127. As described herein, the delivery choice selections stored in the delivery analytics databases 127 may be associated with the transaction information. Thus, the delivery choice selections may be retrieved from the delivery analytics databases 127 that correspond to the buyer.

At operation 930, the delivery personalization system 123 may provide the personalized delivery choices based on the transaction information and the prior delivery choice selections associated with the buyer. For example, the prior transaction data associated with the delivery choice selections retrieved may be used to determine a preferable delivery choice for the transaction data received at operation 910. For instance, the item information in the transaction data may be compared to the item information from the prior transaction data and a preferable delivery choice determined for a particular item. For a concrete example, if a buyer has in the past purchased video games and has frequency chosen the fastest delivery choice when purchasing video games, the buyer may prefer a fast delivery choice when buying a video game. In yet another example, if the buyer has in the past purchased office supplies and frequency chose the least expensive delivery choice, the buyer may prefer less expensive delivery choices when purchasing office supplies.

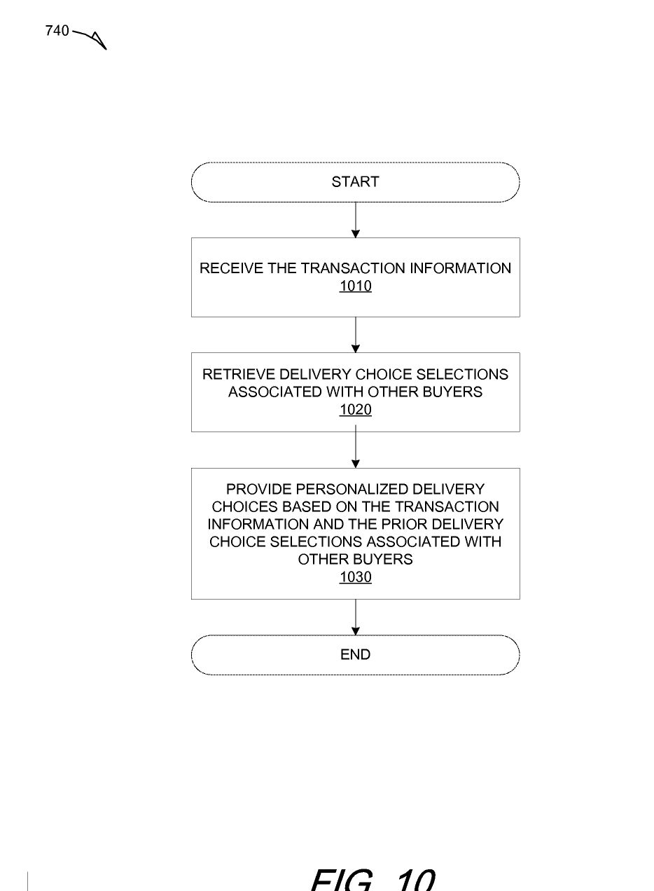

FIG. 10 is an example embodiment that may perform analysis of the delivery analytics data based on delivery choice selections of other buyers. At operation 1010, the delivery personalization system 123 may receive the transaction information. At operation 1020, the delivery personalization system 123 may retrieve the delivery choice selections that are associated with other buyers from, for example, the delivery analytics databases 127.

At operation 1030, the delivery personalization system 123 may provide the personalized delivery choices based on the transaction information and the prior delivery choice selections associated with other buyers. For example, the transaction information may contain buyer location as previously described. The buyer location may be used to determine a delivery choice preference for a particular location or region. For instance, if many buyers in a particular region use a particular delivery choice, then that delivery choice may be preferable for the current transaction. For a concrete example, buyers who live in a very rainy region, such as Seattle, may prefer a delivery choice that is door-to-door.

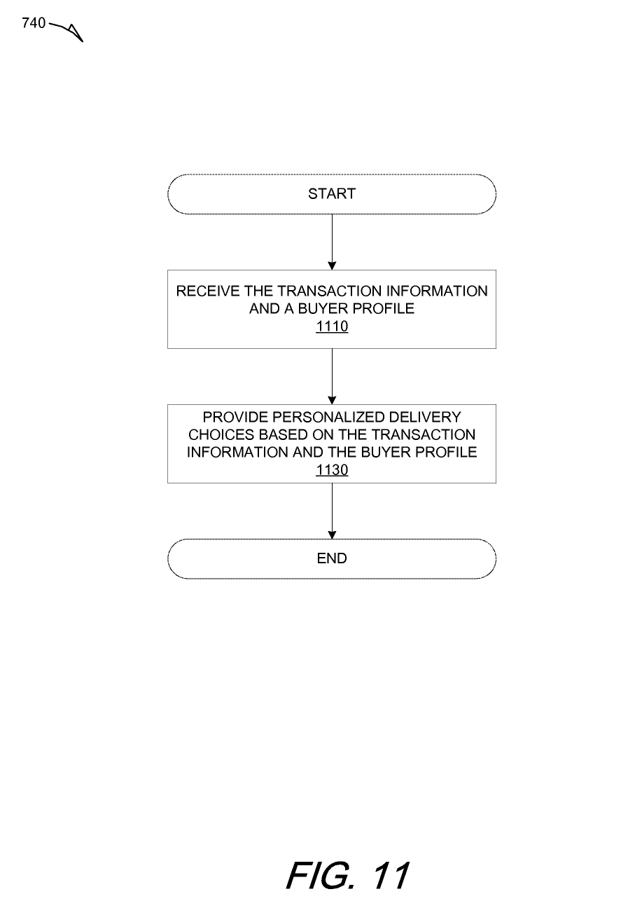

FIG. 11 is an example embodiment of operation 740 that may perform analysis of the delivery analytics data based on the buyer profile. At operation 1110, the delivery personalization system 123 may receive the transaction information and the buyer profile. As described herein, the buyer profile may include information about the buyer such as age, location, prior delivery choice selections, socioeconomic status, income level, and so forth. At operation 1130, the delivery personalization system 123 may provide the personalized delivery choices based on the transaction information and the buyer profile. For example, low-income buyers may prefer less expensive delivery choices compared to high-income buyers.

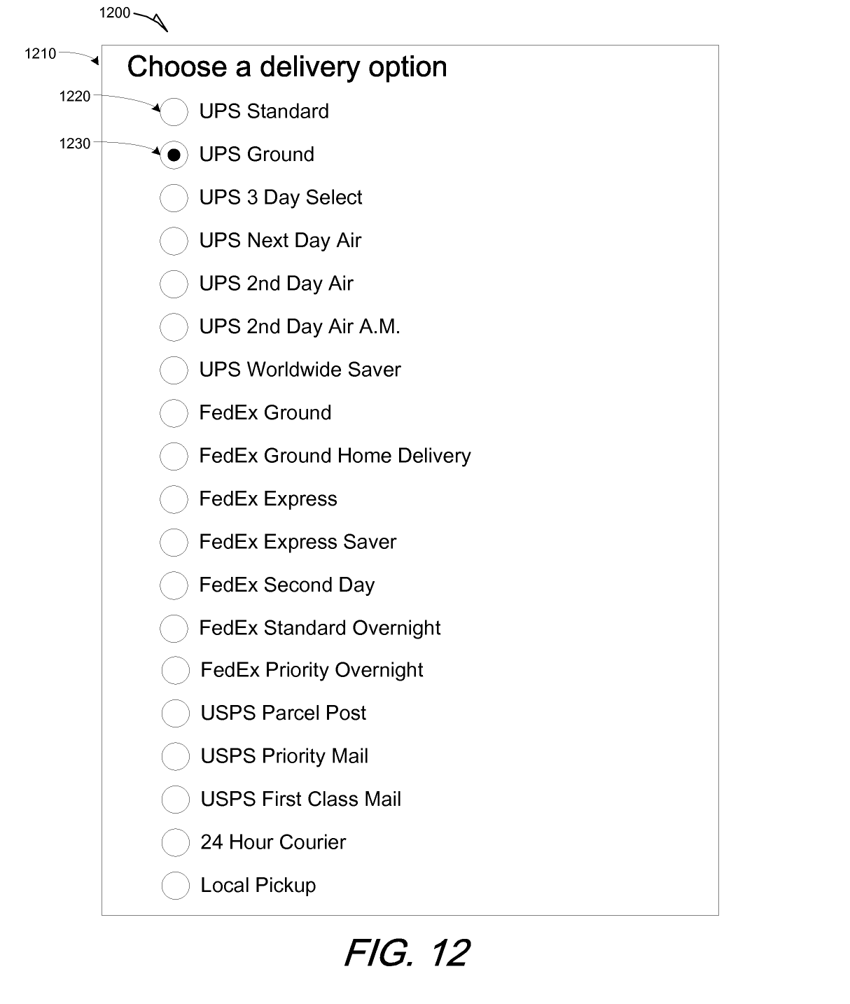

FIG. 12 depicts an example user interface 1200 displaying example delivery choices to the buyer. The user interface module 510 may be configured to display the example user interface 1200. User interface (UI) element 1210 may contain a variety of delivery choices. In the example user interface 1200, the available delivery choices are displayed. The available delivery choices may be identified at operation 720, in an example embodiment. UI element 1220 depicts a single delivery choice that is not selected. UI element 1230 depicts a delivery choice that is selected. The buyer may make the delivery choice selection by selecting one of the displayed delivery choices contained in the UI element 1210. Many other user interfaces may be employed to display the delivery choices.

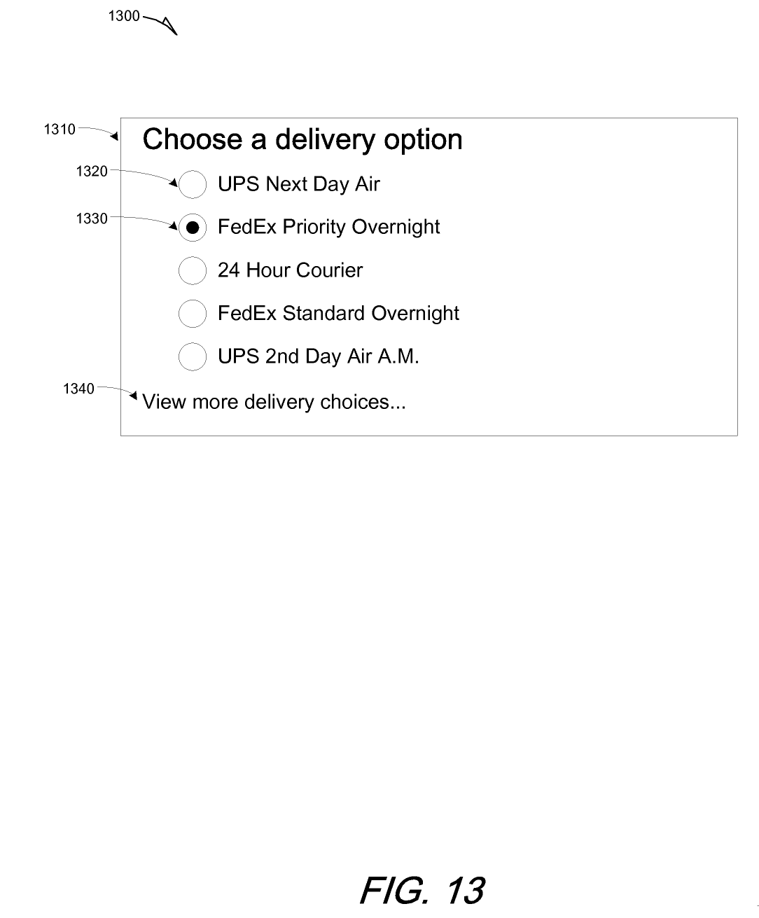

FIG. 13 depicts an example user interface 1300 displaying example personalized delivery choices to the buyer. UI element 1310 may contain the personalized delivery choices. The personalized delivery choices may be determine at operation 740 from the available delivery choices, in an example embodiment. UI element 1320 depicts a single personalized delivery choice. UI element 1330 depicts a personalized delivery choice that is selected. UI element 1340 may be used to display other available delivery choices. By activating the UI element 1340, the UI element 1310 may contain all available delivery choices or simply a few additional personalized delivery choices. In some embodiments, activating UI element 1340 may display a user interface similar to FIG. 12, where the available delivery choices are displayed to the buyer. In this example, the buyer may prefer a fast delivery and the delivery choices are personalized to the buyer's preference for speed. Here, faster delivery choices are contained in the UI element 1310. Many other user interfaces may be employed to display the personalized delivery choices.

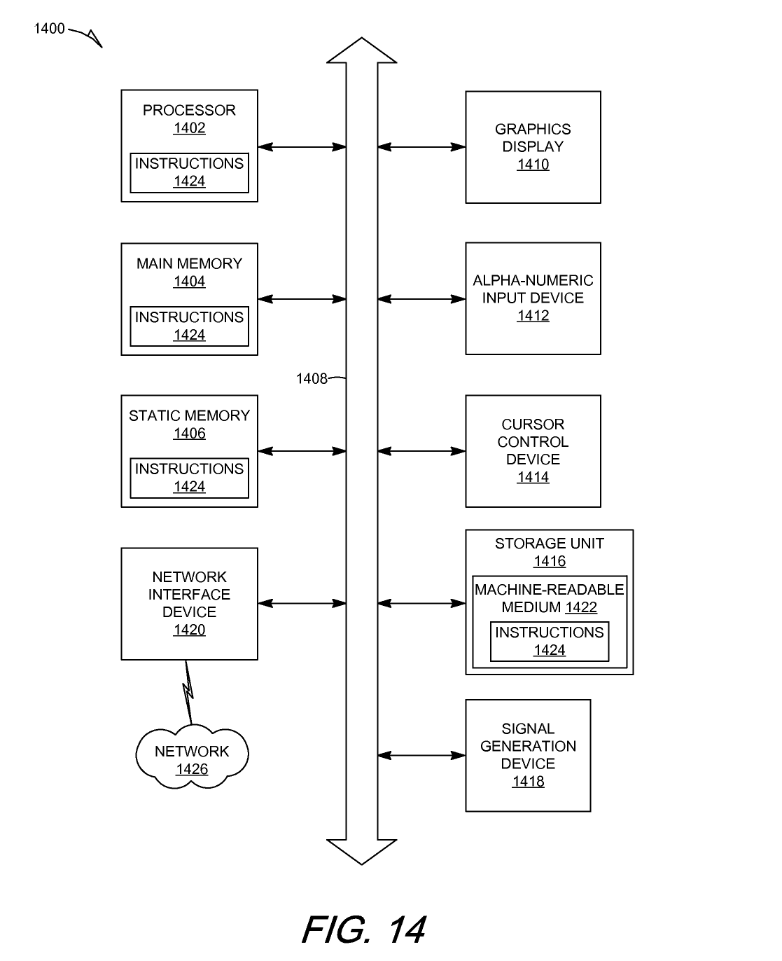

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system and within which instructions 1424 (e.g., software, a program, an application, an applet, an app, or other executable code) for causing the machine 1400 to perform any one or more of the methodologies discussed herein may be executed. In alternative embodiments, the machine 1400 operates as a standalone device or may be connected (e.g., networked) to other machines. In a networked deployment, the machine 1400 may operate in the capacity of a server machine or a client machine in a server-client network environment, or as a peer machine in a peer-to-peer (or distributed) network environment. The machine 1400 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1424, sequentially or otherwise, that specify actions to be taken by that machine. Further, while only a single machine is illustrated, the term “machine” shall also be taken to include a collection of machines that individually or jointly execute the instructions 1424 to perform any one or more of the methodologies discussed herein.

The machine 1400 includes a processor 1402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1404, and a static memory 1406, which are configured to communicate with each other via a bus 1408. The machine 1400 may further include a graphics display 1410 (e.g., a plasma display panel (PDP), a light emitting diode (LED) display, a liquid crystal display (LCD), a projector, or a cathode ray tube (CRT)). The machine 1400 may also include an alphanumeric input device 1412 (e.g., a keyboard), a cursor control device 1414 (e.g., a mouse, a touchpad, a trackball, a joystick, a motion sensor, or other pointing instrument), a storage unit 1416, a signal generation device 1418 (e.g., a speaker), and a network interface device 1420.

The storage unit 1416 includes a machine-readable medium 1422 on which is stored the instructions 1424 embodying any one or more of the methodologies or functions described herein. The instructions 1424 may also reside, completely or at least partially, within the main memory 1404, within the processor 1402 (e.g., within the processor's cache memory), or both, during execution thereof by the machine 1400. Accordingly, the main memory 1404 and the processor 1402 may be considered as machine-readable media. The instructions 1424 may be transmitted or received over a network 1426 via the network interface device 1420.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1422 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1400), such that the instructions, when executed by one or more processors of the machine (e.g., processor 1402), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. Furthermore, the machine-readable medium is non-transitory in that it does not embody a propagating signal. However, labeling the machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1424 may further be transmitted or received over a communications network 1426 using a transmission medium via the network interface device 1420 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
a transaction module executable by a processor and configured to receive a delivery request from a buyer, the delivery request includes transaction information;
the transaction module further configured to identify available delivery choices based on the transaction information;
a delivery analytics data module configured to retrieve delivery analytics data associated with the transaction information from at least one application server;
a delivery analysis module configured to determine personalized delivery choices from the identified available delivery choices based on an analysis of the delivery analytics data; and
the transaction module further configured to recommend the personalized delivery choices to the buyer.

2. The system of claim 1, further comprising:
the delivery analytics data module further configured to store a delivery choice selection and the transaction information associated with the delivery choice selection in a database, to be used in additional analysis by the delivery analysis module in the future.

3. The system of claim 1, wherein the delivery analytics data includes prior delivery choice selections and prior transaction information.

4. The system of claim 3, wherein the analysis includes an analysis of the prior delivery choice selections associated with the buyer.

5. The system of claim 3, wherein the analysis includes analyzing the prior delivery choice selections associated with a plurality of other buyers.

6. The system of claim 1, wherein the delivery analytics data includes a buyer profile; and
the analysis includes an analysis of the buyer profile.

7. The system of claim 1, wherein the delivery analytics data includes buyer delivery preferences; and
the analysis includes an analysis the buyer delivery preferences.

8. A method, comprising:
receiving a delivery request from a buyer, the delivery request including transaction information;
identifying available delivery choices based on the transaction information;
retrieving delivery analytics data associated with the transaction information from at least one application server;
using a processor to determine personalized delivery choices from the identified available delivery choices based on an analysis of the delivery analytics data; and
configuring the processor to recommend the personalized delivery choices to the buyer.

9. The method of claim 8, further comprising:
storing the delivery choice selection and the transaction information associated with the delivery choice selection in a database, to be used in additional analysis in the future.

10. The method of claim 8, wherein the delivery analytics data includes prior delivery choice selections and prior transaction information.

11. The method of claim 10, wherein the analysis includes analyzing the prior delivery choice selections associated with the buyer.

12. The method of claim 10, wherein the analysis includes analyzing the prior delivery choice selections associated with a plurality of other buyers.

13. The method of claim 8, wherein the delivery analytics data includes a buyer profile; and
the analysis includes analyzing the buyer profile.

14. The method of claim 8, wherein the delivery analytics data includes buyer delivery preferences; and
the analysis includes analyzing the buyer delivery preferences.

15. A non-transitory machine readable medium that stores instructions that, when executed by a machine, cause the machine to:
receive a delivery request from a buyer, the delivery request to include transaction information;
identify available delivery choices based on the transaction information;
retrieve delivery analytics data associated with the transaction information from at least one application server;
use a processor to determine personalized delivery choices from the identified available delivery choices based on an analysis of the delivery analytics data; and
configure the processor to recommend the personalized delivery choices to the buyer.

16. The non-transitory machine readable medium of claim 15, further comprising:
store the delivery choice selection and the transaction information associated with the delivery choice selection in a database, to be used in additional analysis in the future.

17. The non-transitory machine readable medium of claim 15, wherein the delivery analytics data includes prior delivery choice selections and prior transaction information.

18. The non-transitory machine readable medium of claim 17, wherein the analysis includes analyzing the prior delivery choice selections associated with the buyer.

19. The non-transitory machine readable medium of claim 17, wherein the analysis includes analyzing the prior delivery choice selections associated with a plurality of other buyers.

20. The non-transitory machine readable medium of claim 15, wherein the delivery analytics data includes a buyer profile; and
the analysis includes analyzing the buyer profile.
